(19) United States
(12) Patent Application Publication
(10) Pub. No.: US 2012/0135345 A1
(43) Pub. Date: May 31, 2012

(54) DEVELOPER, METHOD FOR PRODUCING THE SAME, AND METHOD FOR EVALUATING THE SAME

(75) Inventor: Takashi Urabe, Shizuoka-ken (JP)

(73) Assignee: TOSHIBA TEC KABUSHIKI KAISHA, Tokyo (JP)

(21) Appl. No.: 13/303,355

(22) Filed: Nov. 23, 2011

Related U.S. Application Data
(60) Provisional application No. 61/417,576, filed on Nov. 29, 2010.

(51) Int. Cl. G03G 9/08; G01N 19/04

(52) U.S. Cl. 430/109.4; 430/109.1; 430/137.11; 73/150 A

(57) ABSTRACT

According to one embodiment, a developer includes a toner which contains toner particles containing a binder resin and a coloring agent and also contains inorganic fine particles added to the surfaces of the toner particles, and is obtained through sieving after adding the inorganic fine particles to the toner particles, wherein a first adhesion force Fa1 (%) of the inorganic fine particles to the toner particles before sieving and a second adhesion force Fa2 (%) of the inorganic fine particles to the toner particles after sieving satisfy the following formulae (1) and (2).

|Fa2−Fa1|<5 (1)

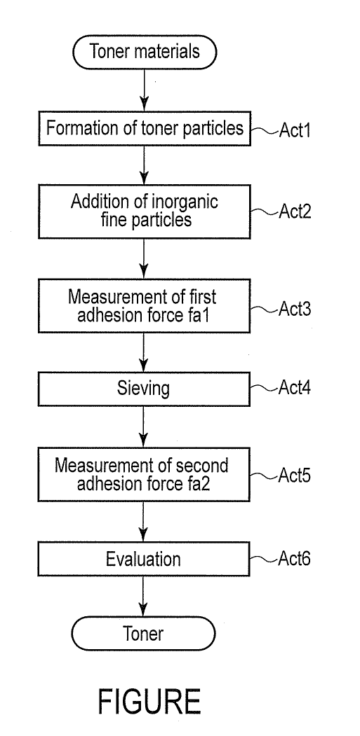

Fa2>65 (2)

### CROSS-REFERENCE TO RELATED APPLICATIONS

This application is based upon and claims the benefit of priority from U.S. Provisional Application No. 61/417,576, filed on Nov. 29, 2010, the entire contents of which are incorporated herein by reference.

### FIELD

Embodiments described herein relate generally to a developer which is used for developing an electrostatic image or a magnetic latent image by an electrophotographic process, an electrostatic printing process, a magnetic recording process, or the like, a method for producing the same, and a method for evaluating the same.

### BACKGROUND

In order to achieve high image quality, the particle diameter of a toner is decreased year by year. As the particle diameter of a toner is decreased, the surface area of a toner is increased, and therefore, the using amount of an additive such as an inorganic oxide to be added to the surfaces of toner particles is also increased year by year. However, it becomes not easy to uniformly adhere a large amount of an additive to the surface of a toner. In general, in order to uniformly adhere an additive to the surface of a toner, it is necessary to increase shear when adding such an additive, and measures are taken that rotor blades are rotated at a high speed or a processing time is prolonged.

Further, as a method for decreasing the particle diameter of a toner, a chemical production method is increasingly used in place of a conventional pulverization method. As the chemical production method, various production methods such as a suspension polymerization method, a dissolution suspension method, an emulsion aggregation method, a phase inversion emulsification method, and a mechanical emulsification method are proposed, however, in any of these production methods, washing and drying steps are required in the latter half of the production process. Washing is generally performed using a centrifugal separator or a filter press, however, whichever device is used, the production process includes a step of compressing a toner to form a cake layer, and therefore, there is a tendency that a toner is more liable to be aggregated as compared with the case of using a pulverization method. Accordingly, a crushing step is adopted after the washing step or crushing is performed after the drying step, whereby aggregates formed in the washing step are reduced.

However, in order to completely crush all the aggregates, the fluidity is required for a toner to some extent, and therefore, final crushing is performed in an external addition step. However, when high shear is applied in a state where aggregates remain in the external addition step, there is a tendency that while crushing is not sufficiently performed, an additive is strongly adhered selectively to the surfaces of some toner particles. Due to this, a toner to which the additive is adhered in a small amount or a toner which has a low additive adhesion force is generated to increase toner scattering, and therefore, there arises an adverse effect of increasing fogging.

### BRIEF DESCRIPTION OF THE DRAWINGS

FIGURE is an exemplary view showing a method for producing a developer according to an embodiment.

### DETAILED DESCRIPTION

In general, according to one embodiment, a developer includes a toner which contains toner particles containing a binder resin and a coloring agent and also contains inorganic fine particles added to the surfaces of the toner particles. This toner is obtained through sieving after adding the inorganic fine particles to the toner particles. Here, the developer is configured such that a first adhesion force Fa1(%) of the inorganic fine particles to the toner particles before sieving and a second adhesion force Fa2(%) of the inorganic fine particles to the toner particles after sieving satisfy the following formulae (1) and (2).

|Fa2−Fa1|<5 (1)

Fa2>65 (2)

The above formula (1) expresses the degree of variation in the additive adhesion force, and a large value indicates that the degree of variation in the additive adhesion force of the toner after sieving is large. If the value of |Fa2−Fa1| is smaller than 5, the degree of variation in the additive adhesion force is small and there is no variation in the properties of the toner. Meanwhile, if the value of |Fa2−Fa1| is larger than 5, there are a lot of toner particles in which the additive adhesion state is different in the toner, and the variation in the properties of the toner is increased.

The toner having a small additive adhesion force is such that the additive is liable to be released from the toner surface when the toner is mixed with a carrier or is stirred in a cartridge, and the adhesion state of the additive is largely changed by the stress imposed by the carrier. As a result, the rise-up of the charging amount of the toner becomes slow or the charging amount of the toner is decreased, and therefore, the deterioration of scattering or fogging tends to be caused. In order to avoid such a phenomenon, it is necessary to adhere the additive to the toner with a given force or more, and Fa2 can be larger than 65% as shown in the above formula (2).

Formulae for calculating Fa1 and Fa2 are shown below.
Fa1=(the Si intensity of a toner which was subjected to the following separation treatment after adding inorganic fine particles and before sieving)/(the Si intensity of a toner after adding inorganic fine particles and before sieving)×100
Fa2=(the Si intensity of a toner which was subjected to the following separation treatment after sieving)/(the Si intensity of a toner after sieving)×100

### Separation Treatment

### Dispersion

In a 100-mL beaker, 11 parts by weight of a toner, 56.8 parts by weight of ion exchanged water, and 12.8 parts by weight of a surfactant are added and mixed, and the resulting mixture is stirred using a magnetic stirrer until a toner layer on the surface of the liquid disappears.

### Impact

A sonic wave is applied to the dispersion liquid for 10 minutes using an ultrasonic washing machine (ASONE US-1R).

### Removal

After the impact step, the dispersion liquid is put into two centrifuge tubes, and ion exchanged water is added to each centrifuge tube to adjust the final volume to 45 ml.

The centrifuge tubes are centrifuged at 1000 rpm for 15 minutes using a centrifugal separator (HSIANGTAI CN-2060).

The supernatant in each of the centrifuge tubes is removed by decantation, and ion exchanged water is added to each centrifuge tube to give a final volume of 45 ml and stirring is performed again.

The step of performing centrifugal separation and the step of removing the supernatant in the centrifuge tube by decantation, adding ion exchanged water to the centrifuge tube, and performing stirring again are performed two more times. In the supernatant, the external additive released from the toner surface by applying a sonic wave is contained, and by this operation, the external additive released from the toner surface can be sufficiently removed.

### Washing

To the toner obtained through the removal, 100 ml of ion exchanged water is added, and filtration is performed. As a filter paper, ADVANTEC GC90 is used.

### Drying

The thus obtained toner is dried under vacuum for 8 hours.

### Measurement of Si Intensity

5.0 g of the toner obtained through the drying is weighed and molded into a pellet using a molding machine.

Measurement is performed using an X-ray fluorescence analyzer (XRF-1800, Shimadzu Corporation) for the pellet prepared through the molding.

Further, the method for producing a developer according to an embodiment includes: forming toner particles using toner materials such as a binder resin and a coloring agent; forming a toner by adding inorganic fine particles to the surfaces of the toner particles; measuring a first adhesion force Fa1(%) of the inorganic fine particles to the toner particles; sieving the toner; measuring a second adhesion force Fa2(%) of the inorganic fine particles to the toner particles in the toner after sieving; and examining whether or not the first adhesion force Fa1(%) and the second adhesion force Fa2(%) satisfy the following formulae (1) and (2).

|Fa2−Fa1<5 (1)

Fa2>65 (2)

Hereinafter embodiments of this disclosure will be described in more detail with reference to the drawing.

FIGURE is a flow diagram showing an exemplary method for producing a developer according to an embodiment.

As shown in the drawing, in the method for producing a developer according to an embodiment, first, toner materials are prepared, and toner particles are formed using the toner materials (Act 1). Then, inorganic fine particles are added to the surfaces of the toner particles (Act 2). Subsequently, a first adhesion force Fa1(%) is measured (Act 3). Thereafter, the toner is sieved (Act 4). Then, a second adhesion force Fa2(%) is measured (Act 5). Thereafter, an evaluation is made as to whether or not the values of Fa1 and Fa2 satisfy the formulae (1) and (2) (Act 6), whereby a toner is obtained.

Further, the method for evaluating a developer according to an embodiment is a method for evaluating a developer containing a toner which contains toner particles containing a binder resin and a coloring agent and also contains inorganic fine particles added to the surfaces of the toner particles, and is obtained through sieving after adding the inorganic fine particles to the toner particles. In the method, a first adhesion force Fa1(%) of the inorganic fine particles to the toner particles before sieving and a second adhesion force Fa2(%) of the inorganic fine particles to the toner particles after sieving are measured, and an examination is made as to whether or not the first adhesion force Fa1(%) and the second adhesion force Fa2(%) satisfy the following formulae (1) and (2).

|Fa2−Fa1|<5 (1)

Fa2>65 (2)

If the adhesion force of the inorganic fine particles to the toner particles is low, when the toner is sieved, the inorganic fine particles are separated and remain on the sieve. By measuring the adhesion force before and after sieving the toner and examining whether or not Fa1 and Fa2 satisfy the above formulae (1) and (2), it can be known whether or not the distribution of the additive adhered to the surfaces of the toner particles is uniform.

There are multiple causes for the additive adhesion force variation or distribution, and one of the causes is a change in the surface area. The surface area can be increased by applying a load to the toner particles in a stirring device in the addition step so as to loosen the aggregated toner particles. In the addition step, a contact time between the additive and the toner particles is different between the case where the toner particles are initially loosened and the case where the toner particles are loosened during the addition step, and therefore, the additive adhesion force variation or distribution can be caused.

The toner particles can be formed by a pulverization method, a chemical method, or the like. As the chemical method, there are various production methods such as a suspension polymerization method, a dissolution suspension method, and an emulsion aggregation method. However, as a chemical method which is suitable for low temperature fixing and in which an organic solvent is not used, for example, there is a method in which fine particles containing a binder resin and a coloring agent are aggregated and fused in an aqueous medium, whereby a toner is obtained. The toner particles obtained by a pulverization method are less aggregated, and therefore, a change in the surface area is less. Meanwhile, in the case of a toner obtained by a chemical method, the toner particles are more liable to be aggregated by being subjected to, for example, a centrifugal separator when removing a medium, and therefore, the effect of the embodiment of this disclosure can be more significantly exhibited.

The inorganic fine particles can be incorporated in an amount of 2% by weight or more based on the amount of the toner particles. Further, the inorganic fine particles can be incorporated in an amount of from 2 to 10% by weight based on the amount of the toner particles.

If the amount of the inorganic fine particles is less than 2% by weight, a spacer effect of the external additive is not sufficiently exhibited, and blocking resistance tends to be deteriorated. Meanwhile, if the amount of the inorganic fine particles exceeds 10% by weight, the fixing property tends to be deteriorated.

The toner according to the embodiment can have a volume average particle diameter of from 4.0 to 7.0

If the volume average particle diameter of the toner is less than 4.0 μm, there is a tendency that the development amount cannot be ensured or the scattered amount cannot be suppressed. Meanwhile, if the volume average particle diameter of the toner exceeds 7.0 the reproducibility of an isolated point or a fine line tends to be deteriorated.

As the binder resin, a polyester resin having an acid value of 10 or more and a glass transition point of 45° C. or higher can be used.

Further, the polyester resin can have an acid value of from 10 to 30 mgKOH/g and a glass transition point of from 45 to 60° C.

If the acid value of the polyester resin is less than 10 mgKOH/g, the dispersibility of resin fine particles in water is deteriorated and the size of the particle tends to be increased when forming a toner. Meanwhile if the acid value of the polyester resin exceeds 30 mgKOH/g, the amount of water adsorbed onto the surface of the toner is increased, and the charging stability tends to be deteriorated.

Further, if the glass transition point is lower than 45° C., the storage stability tends to be insufficient. Meanwhile, if the glass transition point exceeds 60° C., the lower limit temperature of a fixing device at which fixing can be achieved tends to be increased.

The embodiment can be also applied to a decolorizable toner obtained using a leuco dye as the coloring agent.

Hereinafter, embodiments will be described.

Examples of the binder resin to be used in the embodiment include styrene-based resins such as polystyrene, styrene/butadiene copolymers, and styrene/acrylic copolymers; ethylene-based resins such as polyethylene, polyethylene/vinyl acetate copolymers, polyethylene/norbornene copolymers, and polyethylene/vinyl alcohol copolymers; polyester resins, acrylic resins, phenolic resins, epoxy-based resins, allyl phthalate-based resins, polyamide-based resins, and maleic acid-based resins. These resins can be used alone or in combination of two or more kinds thereof. In consideration of the fixing property, a polyester resin can be used.

As the coloring agent to be used in the embodiment, a carbon black, an organic or inorganic pigment or dye, or the like is used. Examples of the carbon black include acetylene black, furnace black, thermal black, channel black, and Ketjen black. Examples of the pigment or dye include fast yellow G, benzidine yellow, indofast orange, irgajin red, naphthol azo, carmen FB, permanent bordeaux FRR, pigment orange R, lithol red 2G, lake red C, rhodamine FB, rhodamine B lake, phthalocyanine blue, pigment blue, brilliant green B, phthalocyanine green, and quinacridone.

Examples of a yellow pigment include C.I. Pigment Yellow 1, 2, 3, 4, 5, 6, 7, 10, 11, 12, 13, 14, 15, 16, 17, 23, 65, 73, 74, 81, 83, 93, 95, 97, 98, 109, 117, 120, 137, 138, 139, 147, 151, 154, 167, 173, 180, 181, 183, and 185; and C.I. Vat Yellow 1, 3, and 20. These can be used alone or in admixture.

Examples of a magenta pigment include C.I. Pigment Red 1, 2, 3, 4, 5, 6, 7, 8, 9, 10, 11, 12, 13, 14, 15, 16, 17, 18, 19, 21, 22, 23, 30, 31, 32, 37, 38, 39, 40, 41, 48, 49, 50, 51, 52, 53, 54, 55, 57, 58, 60, 63, 64, 68, 81, 83, 87, 88, 89, 90, 112, 114, 122, 123, 146, 150, 163, 184, 185, 202, 206, 207, 209, and 238; C.I. Pigment Violet 19; and C.I. Vat Red 1, 2, 10, 13, 15, 23, 29, and 35. These can be used alone or in admixture.

Examples of a cyan pigment include C.I. Pigment Blue 2, 3, 15, 16, and 17; C.I. Vat Blue 6, and C.I. Acid Blue 45. These can be used alone or in admixture.

In the embodiment, a wax can be blended. Examples of the wax include aliphatic hydrocarbon-based waxes such as low-molecular weight polyethylenes, low-molecular weight polypropylenes, polyolefin copolymers, polyolefin waxes, microcrystalline waxes, paraffin waxes, and Fischer-Tropsch waxes; oxides of an aliphatic hydrocarbon-based wax such as polyethylene oxide waxes or block copolymers thereof; vegetable waxes such as candelilla wax, carnauba wax, Japan wax, jojoba wax, and rice wax; animal waxes such as beeswax, lanolin, and spermaceti wax; mineral waxes such as ozokerite, ceresin, and petrolactum; waxes containing, as a main component, a fatty acid ester such as montanic acid ester wax and castor wax; and deoxidization products resulting from deoxidization of a part or the whole of a fatty acid ester such as deoxidized carnauba wax. Further, saturated linear fatty acids such as palmitic acid, stearic acid, montanic acid, and long-chain alkyl carboxylic acids having a long-chain alkyl group; unsaturated fatty acids such as brassidic acid, eleostearic acid, and parinaric acid; saturated alcohols such as stearyl alcohol, eicosyl alcohol, behenyl alcohol, carnaubyl alcohol, ceryl alcohol, melissyl alcohol, and long-chain alkyl alcohols having a long-chain alkyl group; polyhydric alcohols such as sorbitol; fatty acid amides such as linoleic acid amide, oleic acid amide, and lauric acid amide; saturated fatty acid bisamides such as methylenebis stearic acid amide, ethylenebis caprylic acid amide, ethylenebis lauric acid amide, and hexamethylenebis stearic acid amide; unsaturated fatty acid amides such as ethylenebis oleic acid amide, hexamethylenebis oleic acid amide, N,N′-dioleyl adipic acid amide, and N,N′-dioleyl sebaccic acid amide; aromatic bisamides such as m-xylenebis stearic acid amide and N,N′-distearyl isophthalic acid amide; fatty acid metal salts (generally called metallic soaps) such as calcium stearate, calcium laurate, zinc stearate, and magnesium stearate; waxes obtained by grafting a vinyl-based monomer such as styrene or acrylic acid onto an aliphatic hydrocarbon-based wax; partially esterified products of a fatty acid and a polyhydric alcohol such as behenic acid monoglyceride; and methyl ester compounds having a hydroxyl group obtained by hydrogenation of a vegetable fat or oil can be exemplified.

In the embodiment, a charge control agent or the like for controlling a triboelectric charge amount can be blended. As the charge control agent, a metal-containing azo compound is used, and a complex or a complex salt in which the metal element is iron, cobalt, or chromium, or a mixture thereof can be used. Further, a metal-containing salicylic acid derivative compound is also used, and a complex or a complex salt in which the metal element is zirconium, zinc, chromium, or boron, or a mixture thereof can be used.

As a pH adjusting agent which can be used in the embodiment, for example, other than sodium hydroxide, potassium hydroxide, or the like, an amine compound can be used. Examples of the amine compound include dimethylamine, trimethylamine, monoethylamine, diethylamine, triethylamine, propylamine, isopropylamine, dipropylamine, butylamine, isobutylamine, sec-butylamine, monoethanolamine, diethanolamine, triethanolamine, triisopropanolamine, isopropanolamine, dimethylethanolamine, diethylethanolamine, N-butyldiethanolamine, N,N-dimethyl-1,3-diaminopropane, and N,N-diethyl-1,3-diaminopropane.

In the embodiment, a surfactant can be blended. Examples of the surfactant include anionic surfactants such as sulfate ester salt-based, sulfonate salt-based, phosphate ester-based, and soap-based anionic surfactants; cationic surfactants such as amine salt-based and quaternary ammonium salt-based cationic surfactants; and nonionic surfactants such as polyethylene glycol-based, alkyl phenol ethylene oxide adduct-based, and polyhydric alcohol-based nonionic surfactants.

In the embodiment, when the fine particles are aggregated, a water-soluble metal salt can be used. Examples of the water-soluble metal salt include metal salts such as sodium chloride, calcium chloride, calcium nitrate, barium chloride, magnesium chloride, zinc chloride, magnesium sulfate, aluminum chloride, and aluminum sulfate; inorganic metal salt polymers such as polyaluminum chloride, polyaluminum hydroxide, and calcium polysulfide.

In the embodiment, when the fine particles are aggregated, an organic solvent can be used. Examples of the organic solvent which can be used include alcohols such as methanol, ethanol, 1-propanol, 2-propanol, 2-methyl-2-propanol, 2-methoxyethanol, 2-ethoxyethanol, and 2-butoxyethanol; acetonitrile and 1,4-dioxane.

In the embodiment, when the fine particles are aggregated, an acid can be used. Examples of the acid include nitric acid, sulfuric acid, hydrochloric acid, acetic acid, acetic anhydride, phosphoric acid, and citric acid.

In the embodiment, in order to adjust the fluidity or chargeability of the toner particles, inorganic fine particles can be added to the surfaces of the toner particles and mixed therein in an amount of from 2 to 10% by weight based on the amount of the toner particles. As such inorganic fine particles, silica, titania, alumina, strontium titanate, tin oxide, and the like can be used alone or by mixing two or more of them. Those surface-treated with a hydrophobizing agent can be used as the inorganic fine particles from the viewpoint of improvement of the environmental stability. Further, other than such inorganic oxides, resin fine particles having a size of 1 μm or less can be added to the surfaces of the toner particles for improving the cleaning property.

Examples of a mixer for the inorganic fine particles and the like include Henschel Mixer (manufactured by Mitsui Mining Co., Ltd.), Super Mixer (manufactured by Kawata Mfg. Co., Ltd.), Ribocone (manufactured by Okawara Mfg. Co., Ltd.), Nauta Mixer (manufactured by Hosokawa Micron, Co., Ltd.), Turbulizer (manufactured by Hosokawa Micron, Co., Ltd.), Cyclomix (manufactured by Hosokawa Micron, Co., Ltd.), Spiral Pin Mixer (manufactured by Pacific Machinery & Engineering Co., Ltd.), and Lodige Mixer (manufactured by Matsubo Corporation).

In the embodiment, further, coarse particles and the like can be sieved off. Examples of a sieving device which is used for sieving include Ultra Sonic (manufactured by Koei Sangyo Co., Ltd.), Gyro Sifter (manufactured by Tokuju Corporation), Vibrasonic System (manufactured by Dalton Co., Ltd.), Soniclean (manufactured by Shinto Kogyo K.K.), Turbo Screener (manufactured by Turbo Kogyo Co., Ltd.), Micro Sifter (manufactured by Makino Mfg. Co., Ltd.), and a circular vibrating sieve.

Hereinafter, the embodiment of this disclosure will be described more specifically by showing Examples.

### Example 1

### Production of Toner Particles

91 Parts by weight of a polyester resin (acid value: 12, glass transition point: 56° C.) 5 parts by weight of a cyan pigment (ECB-301), and 4 parts by weight of carnauba wax were mixed, and the resulting mixture was processed using a twin-screw kneader which was set to a temperature of 120° C., whereby a kneaded material was obtained. 40 Parts by weight of the thus obtained kneaded material, 2 parts by weight of an anionic surfactant (NEOPELEX G-15), 0.2 parts by weight of an amine compound (trimethylamine) as a pH adjusting agent, and 57.8 parts by weight of ion exchanged water were placed in a CLEARMIX, and after the temperature of the sample reached 120° C., the rotation speed of the CLEARMIX was set to 10,000 rpm, and the sample was stirred for 30 minutes, whereby a fine particle dispersion liquid was prepared. After cooling, the volume average particle diameter of the obtained fine particles was measured using SALD-7000 (manufactured by Shimadzu Corporation) and found to be 0.82 μm. To 25 parts by weight of the thus obtained fine particle dispersion liquid, 75 parts by weight of ion exchanged water was added so as to adjust the solid content concentration was 10 parts by weight. Further, 10 parts by weight of an aqueous solution of 0.1% magnesium sulfate was added, and the temperature of the mixture was gradually raised to 70° C. so as to aggregate the fine particles until the desired volume average particle diameter was reached, whereby toner particles were obtained. In order to maintain the volume average particle diameter of the toner particles, 1 part by weight of an anionic surfactant (NEOPELEX G-15) was added thereto, and in order to control the shape thereof, the temperature of the mixture was raised to 90° C. and the mixture was left stand for 3 hours. After cooling, the obtained toner particles were washed using a centrifugal separator until the conductivity of the washing water became 1 μS/cm or less. Then, the toner particles were dried using a vacuum dryer until the water content became 0.5 wt %.

### Addition of Additives

To the obtained toner particles, 2 parts by weight of RX200 (silica) and 0.5 parts by weight of NKT90 (titanium oxide) were added as additives, and the additives were adhered to the surfaces of the toner particles using a 20-L Henschel Mixer, whereby a toner was obtained. As for the treatment conditions of the Henschel Mixer, the rotation speed was set to 2700 rpm and the treatment time was set to 12 minutes. Fa1 obtained by the measurement after adding the additives was 70.2%. Subsequently, the toner was sieved using a vibrating sieve with a mesh having an opening of 150 μm, whereby a desired toner could be obtained. Fa2 obtained by the measurement after sieving was 73.2%.

The thus obtained toner was placed in an MFP e-STUDIO 4520c which was manufactured by Toshiba Tec Corporation and was modified for evaluation, and a printing endurance test was performed by printing 50,000 sheets of paper. Then, the amount of the toner accumulated in a portion which is provided under a sleeve of a developing device to collect a scattered toner was measured and found to be 26 mg. If the amount of the scattered toner is increased, the toner overflows from the developing device and makes the machine main body dirty, and therefore, the amount of the scattered toner can be 200 mg or less. The value of fogging was measured using a color meter X-Rite 938 manufactured by X-Rite, Incorporated and found to be 0.2, and fogging could not be recognized by visual observation. If the value of fogging exceeds 1, the image is recognized to be poor by human eyes, and therefore, the value of fogging can be 1 or less.

### Example 2

To toner particles obtained in the same manner as in Example 1, 2 parts by weight of RX200 (silica) and 0.5 parts by weight of NKT90 (titanium oxide) were added as additives, and the additives were adhered to the surfaces of the toner particles using a 20-L Henschel Mixer, whereby a toner was obtained. As for the treatment conditions of the Henschel Mixer, the rotation speed was set to 3600 rpm and the treatment time was set to 12 minutes. Fa1 obtained by the measurement after adding the additives was 75.8%. Subsequently, the toner was sieved using a vibrating sieve, whereby a desired toner could be obtained. Fa2 obtained by the measurement after sieving was 76.2%.

The thus obtained toner was placed in an MFP e-STUDIO 4520c which was manufactured by Toshiba Tec Corporation and was modified for evaluation, and a printing endurance test was performed by printing 50,000 sheets of paper. Then, the amount of the toner accumulated in a portion which is provided under a sleeve of a developing device to collect a scattered toner was measured and found to be 12 mg. The value of fogging was 0.1, and a good image could be obtained.

### Example 3

To toner particles obtained in the same manner as in Example 1, 2 parts by weight of RX200 (silica) and 0.5 parts by weight of NKT90 (titanium oxide) were added as additives, and the additives were adhered to the surfaces of the toner particles using a 20-L Henschel Mixer, whereby a toner was obtained. As for the treatment conditions of the Henschel Mixer, the rotation speed was set to 1800 rpm and the treatment time was set to 12 minutes. Fa1 obtained by the measurement after adding the additives was 65.3%. Subsequently, the toner was sieved using a vibrating sieve, whereby a desired toner could be obtained. Fa2 obtained by the measurement after sieving was 69.7%.

The thus obtained toner was placed in an MFP e-STUDIO 4520c which was manufactured by Toshiba Tec Corporation and was modified for evaluation, and a printing endurance test was performed by printing 50,000 sheets of paper. Then, the amount of the toner accumulated in a portion which is provided under a sleeve of a developing device to collect a scattered toner was measured and found to be 59 mg. The value of fogging was 0.4, and a good image could be obtained.

### Example 4

To toner particles obtained in the same manner as in Example 1, 2 parts by weight of RX200 (silica) and 0.5 parts by weight of NKT90 (titanium oxide) were added as additives, and the additives were adhered to the surfaces of the toner particles using a 20-L Henschel Mixer, whereby a toner was obtained. As for the treatment conditions of the Henschel Mixer, the rotation speed was set to 1800 rpm and the treatment time was set to 18 minutes. Fa1 obtained by the measurement after adding the additives was 74.6%. Subsequently, the toner was sieved using a vibrating sieve, whereby a desired toner could be obtained. Fa2 obtained by the measurement after sieving was 74.9%.

The thus obtained toner was placed in an MFP e-STUDIO 4520c which was manufactured by Toshiba Tec Corporation and was modified for evaluation, and a printing endurance test was performed by printing 50,000 sheets of paper. Then, the amount of the toner accumulated in a portion which is provided under a sleeve of a developing device to collect a scattered toner was measured and found to be 15 mg. The value of fogging was 0.2, and a good image could be obtained.

### Comparative Example 1

To toner particles obtained in the same manner as in Example 1, 2 parts by weight of RX200 (silica) and 0.5 parts by weight of NKT90 (titanium oxide) were added as additives, and the additives were adhered to the surfaces of the toner particles using a 20-L Henschel Mixer, whereby a toner was obtained. As for the treatment conditions of the Henschel Mixer, the rotation speed was set to 1500 rpm and the treatment time was set to 12 minutes. Fa1 obtained by the measurement after adding the additives was 56.8%. Subsequently, the toner was sieved using a vibrating sieve, whereby a desired toner could be obtained. Fa2 obtained by the measurement after sieving was 63.8%.

The thus obtained toner was placed in an MFP e-STUDIO 4520c which was manufactured by Toshiba Tec Corporation and was modified for evaluation, and a printing endurance test was performed by printing 50,000 sheets of paper. Then, the amount of the toner accumulated in a portion which is provided under a sleeve of a developing device to collect a scattered toner was measured and found to be 186 mg. The value of fogging was 1.2, and an image with much fogging was obtained.

### Comparative Example 2

To toner particles obtained in the same manner as in Example 1, 2 parts by weight of RX200 (silica) and 0.5 parts by weight of NKT90 (titanium oxide) were added as additives, and the additives were adhered to the surfaces of the toner particles using a 20-L Henschel Mixer, whereby a toner was obtained. As for the treatment conditions of the Henschel Mixer, the rotation speed was set to 3600 rpm and the treatment time was set to 3 minutes. Fa1 obtained by the measurement after adding the additives was 49.6%. Subsequently, the toner was sieved using a vibrating sieve, whereby a desired toner could be obtained. Fa2 obtained by the measurement after sieving was 65.8%.

The thus obtained toner was placed in an MFP e-STUDIO 4520c which was manufactured by Toshiba Tec Corporation and was modified for evaluation, and a printing endurance test was performed by printing 50,000 sheets of paper. Then, the amount of the toner accumulated in a portion which is provided under a sleeve of a developing device to collect a scattered toner was measured and found to be 392 mg. The value of fogging was 1.1, and an image with much fogging was obtained.

According to the above-described configuration, an image with little fogging can be provided.

### Example 5

To toner particles obtained in the same manner as in Example 1, 3 parts by weight of RX200 (silica) and 1 part by weight of NKT90 (titanium oxide) were added as additives, and the additives were adhered to the surfaces of the toner particles using a 20-L Henschel Mixer, whereby a toner was obtained. As for the treatment conditions of the Henschel Mixer, the rotation speed was set to 3200 rpm and the treatment time was set to 12 minutes. Fa1 obtained by the measurement after adding the additives was 72.8%. Subsequently, the toner was sieved using a vibrating sieve (opening: 150 μm), whereby a desired toner could be obtained. Fa2 obtained by the measurement after sieving was 75.9%.

The thus obtained toner was placed in an MFP e-STUDIO 4520c which was manufactured by Toshiba Tec Corporation and was modified for evaluation, and a printing endurance test was performed by printing 50,000 sheets of paper. Then, the amount of the toner accumulated in a portion which is provided under a sleeve of a developing device to collect a scattered toner was measured and found to be 36 mg. The value of fogging was 0.5, and a good image could be obtained.

### Example 6

To toner particles obtained in the same manner as in Example 1, 1 part by weight of RX200 (silica) and 0.25 parts by weight of NKT90 (titanium oxide) were added as additives, and the additives were adhered to the surfaces of the toner particles using a 20-L Henschel Mixer, whereby a toner was obtained. As for the treatment conditions of the Henschel Mixer, the rotation speed was set to 1500 rpm and the treatment time was set to 9 minutes. Fa1 obtained by the measurement after adding the additives was 80.2%. Subsequently, the toner was sieved using a vibrating sieve (opening: 150 μm), whereby a desired toner could be obtained. Fa2 obtained by the measurement after sieving was 81.3%.

The thus obtained toner was placed in an MFP e-STUDIO 4520c which was manufactured by Toshiba Tec Corporation and was modified for evaluation, and a printing endurance test was performed, by printing 50,000 sheets of paper. Then, the amount of the toner accumulated in a portion which is provided under a sleeve of a developing device to collect a scattered toner was measured and found to be 9 mg. The value of fogging was 0.2, and a good image could be obtained.

### Comparative Example 3

To toner particles obtained in the same manner as in Example 1, 3 parts by weight of RX200 (silica) and 1.0 parts by weight of NKT90 (titanium oxide) were added as additives, and the additives were adhered to the surfaces of the toner particles using a 20-L Henschel Mixer, whereby a toner was obtained. As for the treatment conditions of the Henschel Mixer, the rotation speed was set to 2700 rpm and the treatment time was set to 12 minutes. Fa1 obtained by the measurement after adding the additives was 56.4%. Subsequently, the toner was sieved using a vibrating sieve (opening: 150%), whereby a desired toner could be obtained. Fa2 obtained by the measurement after sieving was 62.5%.

The thus obtained toner was placed in an MFP e-STUDIO 4520c which was manufactured by Toshiba Tec Corporation and was modified for evaluation, and a printing endurance test was performed by printing 50,000 sheets of paper. Then, the amount of the toner accumulated in a portion which is provided under a sleeve of a developing device to collect a scattered toner was measured and found to be 172 mg. The value of fogging was 1.1, and an image with much fogging was obtained.

### Comparative Example 4

To toner particles obtained in the same manner as in Example 1, 1 part by weight of RX200 (silica) and 0.25 parts by weight of NKT90 (titanium oxide) were added as additives, and the additives were adhered to the surfaces of the toner particles using a 20-L Henschel Mixer, whereby a toner was obtained. As for the treatment conditions of the Henschel Mixer, the rotation speed was set to 1500 rpm and the treatment time was set to 3 minutes. Fa1 obtained by the measurement after adding the additives was 52.3%. Subsequently, the toner was sieved using a vibrating sieve (opening: 150 μm), whereby a desired toner could be obtained. Fa2 obtained by the measurement after sieving was 64.8%.

The thus obtained toner was placed in an MFP e-STUDIO 4520c which was manufactured by Toshiba Tec Corporation and was modified for evaluation, and a printing endurance test was performed by printing 50,000 sheets of paper. Then, the amount of the toner accumulated in a portion which is provided under a sleeve of a developing device to collect a scattered toner was measured and found to be 299 mg. The value of fogging was 1.3, and an image with much fogging was obtained.

The results obtained for the above-described Examples 1 to 6 and Comparative examples 1 to 4 are shown in the following Table 1.

TABLE 1

| | | | Conditions for external | | | | | | |
|---|---|---|---|---|---|---|---|---|---|
| | Addition | | addition | | | | | Results | |
| | amount (%) | | Rotation | Treatment | Adhesion force (%) | | | Scattered | |
| | SiO₂ | TiO₂ | speed (rpm) | time (min) | Fa1 | Fa2 | \|Fa2 − Fa1\| | amount (mg) | Fogging |
| Example 1 | 2 | 0.5 | 2700 | 12 | 70.2 | 73.2 | 3.0 | 26 | 0.2 |
| Example 2 | 2 | 0.5 | 3600 | 12 | 75.8 | 76.2 | 0.4 | 12 | 0.1 |
| Example 3 | 2 | 0.5 | 1800 | 12 | 65.3 | 69.7 | 4.4 | 59 | 0.4 |
| Example 4 | 2 | 0.5 | 1800 | 18 | 74.6 | 74.9 | 0.3 | 15 | 0.2 |
| Example 5 | 3 | 1 | 3200 | 12 | 72.8 | 75.9 | 3.1 | 36 | 0.5 |
| Example 6 | 1 | 0.25 | 1500 | 9 | 80.2 | 81.3 | 1.1 | 9 | 0.2 |
| Comparative | 2 | 0.5 | 1500 | 12 | 56.8 | 63.8 | 7 | 186 | 1.2 |
| Example 1 | | | | | | | | | |
| Comparative | 2 | 0.5 | 3600 | 3 | 49.6 | 65.8 | 16.2 | 392 | 1.1 |
| Example 2 | | | | | | | | | |
| Comparative | 3 | 1 | 2700 | 12 | 56.4 | 62.5 | 6.1 | 172 | 1.1 |
| Example 3 | | | | | | | | | |
| Comparative | 1 | 0.25 | 1500 | 3 | 52.3 | 64.8 | 12.5 | 299 | 1.3 |
| Example 4 | | | | | | | | | |

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A developer comprising a toner which contains toner particles containing a binder resin and a coloring agent and also contains inorganic fine particles added to the surfaces of the toner particles, wherein
the toner is subjected to sieve after adding the inorganic fine particles to the toner particles, and a first adhesion force Fa1(%) of the inorganic fine particles to the toner particles before sieving and a second adhesion force Fa2(%) of the inorganic fine particles to the toner particles after sieving satisfy the following formulae (1) and (2):

|Fa2−Fa1|<5 (1) and
Fa2>65 (2).

2. The developer according to claim 1, wherein the toner particles are obtained by aggregating and fusing fine particles containing the binder resin and the coloring agent in an aqueous medium.

3. The developer according to claim 1, wherein the inorganic fine particles are contained in an amount of 2% by weight or more based on the amount of the toner particles.

4. The developer according to claim 1, wherein the toner has a volume average particle diameter of from 4.0 to 7.0 μm.

5. The developer according to claim 1, wherein the binder resin is a polyester resin having an acid value of 10 or more and a glass transition point of 45° C. or higher.

6. The developer according to claim 1, wherein the coloring agent is a leuco dye.

7. A method for producing a developer comprising:
forming toner particles containing a binder resin and a coloring agent;
forming a toner by adding inorganic fine particles to the surfaces of the toner particles;
measuring a first adhesion force Fa1(%) of the inorganic fine particles to the toner particles;
sieving the toner;
measuring a second adhesion force Fa2(%) of the inorganic fine particles to the toner particles in the toner after sieving; and
examining whether or not the first adhesion force Fa1(%) and the second adhesion force Fa2(%) satisfy the following formulae (1) and (2):

|Fa2−Fa1|<5 (1) and
Fa2>65 (2).

8. The method according to claim 7, wherein the toner particles are obtained by aggregating and fusing fine particles containing the binder resin and the coloring agent in an aqueous medium.

9. The method according to claim 7, wherein the inorganic fine particles are contained in an amount of 2% by weight or more based on the amount of the toner particles.

10. The method according to claim 7, wherein the toner has a volume average particle diameter of from 4.0 to 7.0 μm.

11. The method according to claim 7, wherein the binder resin is a polyester resin having an acid value of 10 or more and a glass transition point of 45° C. or higher.

12. The method according to claim 7, wherein the coloring agent is a leuco dye.

13. A method for evaluating a developer containing a toner which contains toner particles containing a binder resin and a coloring agent and also contains inorganic fine particles added to the surfaces of the toner particles, and is obtained through sieving after adding the inorganic fine particles to the toner particles, wherein the method comprises:
measuring a first adhesion force Fa1(%) of the inorganic fine particles to the toner particles before sieving and a second adhesion force Fa2(%) of the inorganic fine particles to the toner particles after sieving; and
examining whether or not the first adhesion force Fa1(%) and the second adhesion force Fa2(%) satisfy the following formulae (1) and (2):

|Fa2−Fa1|<5 (1) and
Fa2>65 (2).

14. The method according to claim 13, wherein the toner particles are obtained by aggregating and fusing fine particles containing the binder resin and the coloring agent in an aqueous medium.

15. The method according to claim 13, wherein the inorganic fine particles are contained in an amount of 2% by weight or more based on the amount of the toner particles.

16. The method according to claim 13, wherein the toner has a volume average particle diameter of from 4.0 to 7.0 μm.

17. The method according to claim 13, wherein the binder resin is a polyester resin having an acid value of 10 or more and a glass transition point of 45° C. or higher.

18. The method according to claim 13, wherein the coloring agent is a leuco dye.
